(19) United States
(12) Patent Application Publication
(10) Pub. No.: US 2008/0118598 A1
(43) Pub. Date: May 22, 2008

(54) Method and device for injecting plasticized masses into a mold die of an injection molding machine

(75) Inventors: Volker Krell, Neuhausen (DE); Manfred Dufner, Krauchenwies (DE)

Correspondence Address: COLLARD & ROE, P.C., 1077 NORTHERN BOULEVARD, ROSLYN, NY, 11576, US

(73) Assignee: Klockner Desma Elastomertechnik GmbH

(21) Appl. No.: 11/977,120

(22) Filed: Oct. 23, 2007

(30) Foreign Application Priority Data
Nov. 16, 2006 (DE) 10 2006 054 416.1

(51) Int. Cl. B29C 47/16

(52) U.S. Cl. 425/466; 425/461; 425/467

(57) ABSTRACT

A method for injecting plasticized masses such as rubber, silicone, and the like into a mold die of an injection-molding machine, directly or by way of a cold channel, uses a nozzle whose opening width can be changed. The opening width is maximal at the beginning of the injection process, and is changed over the course of the injection process, up to its end, using a predetermined control profile. The temperature of the mass is influenced in a targeted manner in accordance with the opening width, and the friction losses in the mass that change as a result of this.

### BACKGROUND OF THE INVENTION

1. Field of the Invention

The invention relates to a method and a device for injecting plasticized masses such as rubber, silicone, and the like into a mold die of an injection-molding machine, directly or by way of a cold channel, by means of a nozzle whose opening width can be changed.

2. The Prior Art

When producing rubber parts in an injection-molding machine, the non-vulcanized raw rubber is injected, directly or by way of a cold channel, into the mold inserts of an injection-molding die, by way of a plastification and injection unit on which such a nozzle is provided.

Within the injection unit, the plasticized mass has a temperature of about 80°, at which vulcanization is still prevented. In the mold die, a temperature of about 150° prevails, at which vulcanization takes place.

However, in order to ensure that vulcanization does not take place over the course of time in the region between injection opening and mold die, causing this region to become clogged, the nozzle or the cold channel has a corresponding cooling or tempering system.

Since, in this case, a “cold” mass enters into the vulcanization chamber, there are problems regarding the quality of the articles to be produced, and also regarding the length of the vulcanization time.

### SUMMARY OF THE INVENTION

It is therefore an object of the invention to provide a method in which the vulcanization time in the die can be reduced by means of targeted heating of the mass that reaches the mold cavity.

The invention accomplishes this object in that the opening width is maximal at the beginning of the injection process, and the opening width of the nozzle is changed over the course of the injection process, up to its end, using a predetermined control profile. The temperature of the mass is influenced in a targeted manner in accordance with the opening width, and the friction losses in the mass change as a result of this.

In this way, it is possible to directly influence the temperature of the mass by varying the opening width, while this would only be possible indirectly and with a time delay by way of the existing tempering system.

At the beginning of this injection process, the nozzle opening is set to the maximal open position, so that the flow process of the mass can begin. Then, over the course of the injection process, the opening is reduced to 30%, for example, thereby causing targeted heating to occur directly in the mass, due to internal friction, and now a temperature prevails in the mass that allows it to vulcanize out in the mold die in an accelerated manner. At the end of the injection process, the maximal open position is then set once again.

In order to implement the method, a nozzle is therefore required whose nozzle opening can be adjusted in a stepless manner, from a maximal open position all the way to a closed position.

Such a nozzle is known, for example, from German Patent No. DE 103 21 355.4 A1.

Here, a needle is provided for closing and opening the nozzle opening, which needle forms the part of an insert on the nozzle opening side that is displaceable axially relative to the nozzle body, by means of a drive. An electric motor or a pressure-operated lifting cylinder can be provided as the drive.

The invention also relates to a nozzle in which the drive unit is connected with a holder ring, by way of pushing rods disposed outside of the nozzle body. The ring surrounds the nozzle body at the level of the insert and is mounted to be axially displaceable on the nozzle body. Several pins are disposed in the holder ring radial to the center axis of the nozzle, and project into a ring-shaped indentation in the insert with their ends that face inward. A piston in the manner of a ring flange, to which pressure can be applied on two sides, is disposed on the nozzle body. The piston is surrounded by a housing that surrounds the nozzle body and is axially displaceable on the nozzle body. The housing lid of the housing, pointing in the direction of the nozzle opening, which closes off the face of the housing, serves as support for the pushing rods that engage on the holder ring.

In a particularly simple embodiment of the nozzle, the nozzle body and the piston form a structural unit.

Closure of the nozzle takes place by way of the conical surface of the conical front end of the insert with the threaded ring. Here, the nozzle body plays the role of a piston rod, where the piston rod and piston rest in operation, while the housing alone moves in the axial direction when pressure is applied to the housing.

Since the pushing rods are attached to the housing, the housing movement is transferred to the holder ring and therefore to the pins that lead to the insert, and therefore, in the final analysis, to the insert itself. The housing lid has an outside thread, so that it can be screwed into the housing. It is then sealed towards the outside. The four pushing rods are rigidly connected with the lid by way of threaded bores, and transfer the movement to the holder ring.

Cooling was also provided in the nozzle mentioned above, according to the state of the art, in the front region of the nozzle, but in the cold channel itself. However, with the nozzle according to the invention, the nozzle body is surrounded by an annular chamber for accommodating and guiding a cooling medium. The annular chamber is welded together from three parts, for example, namely from the inner ring that is set onto the nozzle body, and an outer ring that is welded to the inner ring. In the interior, a crosspiece ensures the separation of inlet and outlet, and circulation of the cooling medium. Because of the cylindrical cooling or tempering, it is possible for the nozzle to be immersed relatively far into the solid clamping plate.

In order for the housing movement to be able to be transferred onto the insert by way of the pushing rods and the holder ring, the pins that lead from the holder ring to the insert are passed through oblong bores in the nozzle body, which have a length corresponding to the stroke path of the piston.

As known from the state of the art, the material-guiding channel in the insert ends in bores that end before the actual needle region in the nozzle mouthpiece begins. This nozzle mouthpiece is formed by an approximately conical threaded ring that is screwed onto the front end of the nozzle body.

### BRIEF DESCRIPTION OF THE DRAWING

Other objects and features of the present invention will become apparent from the following detailed description considered in connection with the accompanying drawing. It is to be understood, however, that the drawing is designed as an illustration only and not as a definition of the limits of the invention.

FIG. 1 shows a needle closure nozzle according to an embodiment of the invention.

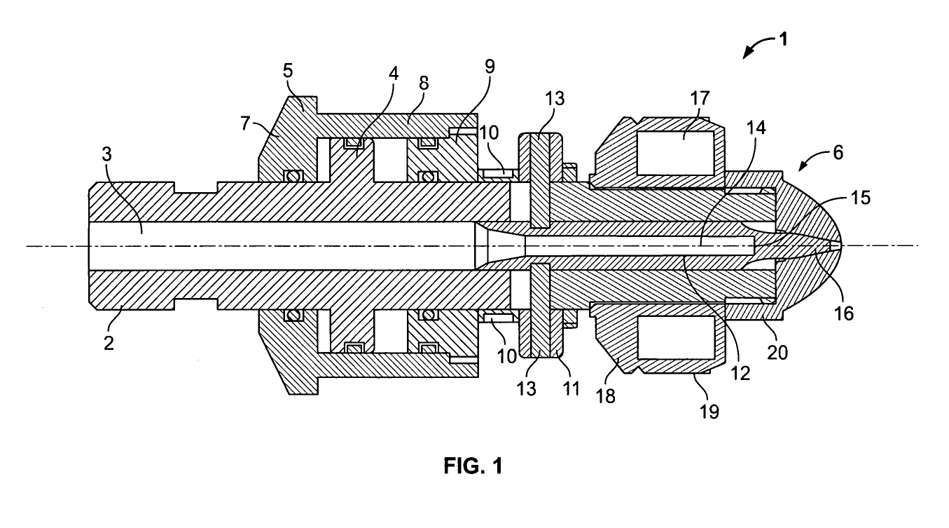

### DETAILED DESCRIPTION OF THE PREFERRED EMBODIMENT

A needle closure nozzle is shown in the single drawing, and designated, in general, with the reference symbol 1. It consists of a nozzle body 2 that has a channel 3 passing through it over its full length. A piston 4 in the manner of a ring flange is situated on nozzle body 2, which piston is surrounded by a housing 5 that is displaceable on the nozzle body in the axial direction. Housing 5 has a rear wall 7 that faces away from nozzle mouthpiece 6, which wall is connected, in one piece, with housing mantle 8. In the direction of mouthpiece 6, housing 5 is closed off with a housing lid 9 that is screwed into mantle 8 by a screw thread. Housing 5 therefore forms a cylinder that is sealed towards the outside, in which piston 4 is disposed.

Pushing rods 10 are screwed into housing lid 9, which rods are attached to a holder ring 11, which surrounds nozzle body 2 in the region of an insert 12 that is axially displaceable in channel 3. Pins 13 lead radially from holder ring 11 to insert 12, which pins project into a ring-shaped indentation in insert 12 with their ends that face inward.

Insert 12 has a channel 14 that runs axially and carries material, which channel ends in openings 15 that form the connection to channel 3 in front of needle-shaped tip 16. In the closed position shown, the conical surface of tip 16 lies in a correspondingly shaped complementary surface in nozzle mouthpiece 6, which mouthpiece is formed by a threaded ring 20 that is screwed onto the front end of nozzle body 2.

An annular chamber 17 surrounds nozzle body 2 between nozzle mouthpiece 6 and holder ring 11, for accommodating and guiding a cooling medium. Annular chamber 17 is formed by an inner ring 18 that is pushed onto nozzle body 2, and an outer ring 19 that is welded to the former. In the interior, a crosspiece, not shown, assures separation of inlet and outlet and circulation of the cooling medium.

In operation, nozzle 1 is laid against the casting channel of a mold die, not shown, by means of the solid clamping plate, also not shown, of an injection-molding machine. The housing is displaced on nozzle body 2, in the axial direction, by means of applying force to piston 4; this causes insert 12 to be moved, as well, by way of pushing rods 10, holder ring 11, and pins 13.

The material that comes from a plastification unit enters material-carrying channel 14 of the insert through channel 3, and into the mold die by way of openings 15 and nozzle mouthpiece 6.

In this way, the size of the exit opening can be changed by means of regulated displacement of the insert, thereby intentionally introducing energy into the mass that is injected, since the friction losses that occur in this connection are converted to heat.

The size of the exit opening can then be variably controlled over the entire injection process. The adjustment can be controlled by way of a path measurement, not shown.

Accordingly, while only a few embodiments of the present invention have been shown and described, it is obvious that many changes and modifications may be made thereunto without departing from the spirit and scope of the invention.

What is claimed is:

1. A method for injecting plasticized masses into a mold die of an injection-molding machine, directly or by way of a cold channel, via a nozzle whose opening width can be changed, comprising the following step:
changing the opening width of the nozzle such that the opening width is maximal at a beginning of an injection process and changes during the injection process, said step of changing using a predetermined control profile so that a temperature of the mass is influenced in a targeted manner in accordance with the opening width, as well as friction losses in the mass.

2. A device for injecting plasticized masses into a mold die of an injection-molding machine, directly or by way of a cold channel, comprising;
a nozzle having a nozzle body and a nozzle opening that can be adjusted in a stepless manner, from a maximal open position all the way to a closed position.

3. A device according to claim 2, further comprising an external drive for adjusting the opening width, said drive being controllable by a machine control and a path measurement device.

4. A device according to claim 3, further comprising a needle for controlled closing and opening of the nozzle opening, said needle forming a part of an insert on a nozzle opening side, said insert being axially displaceable relative to the nozzle body by the drive.

5. A device according to claim 4, wherein the insert has a material transport channel that is connected with a nozzle mouthpiece by way of one or more bores on the nozzle opening side.

6. A device according to claim 3, wherein the external drive is an electric motor.

7. A device according to claim 3, wherein the external drive consists of a lifting cylinder.

8. A device according to claim 6, further comprising:
a holder ring connected to the drive by pushing rods disposed outside of the nozzle body, said holder ring surrounding the nozzle body at a level of the insert and being axially displaceable on the nozzle body;
a plurality of pins disposed in the holder ring radial to a center axis of the nozzle, said pins projecting into a ring-shaped indentation in the insert with their ends that face inward;
a piston formed as a ring flange, to which pressure can be applied on two sides, disposed on the nozzle body, said piston being surrounded by a housing that surrounds the nozzle and is axially displaceable on the nozzle body; and
a housing lid of the housing, said lid pointing in a direction of the nozzle opening, and closing off a face of the housing and supporting the pushing rods that engage on the holder ring.

9. A device according to claim 8, wherein the nozzle body and piston form a structural unit.

10. A device according to claim 6, wherein the nozzle body is surrounded by an annular chamber for accommodating and guiding a cooling medium.

11. A device according to claim 8, wherein the pins are passed through oblong bores in the nozzle body, said pins having a length corresponding to a stroke path of the piston.

12. A device according to claim 6, wherein the nozzle mouthpiece is formed by a conically configured threaded ring that is screwed onto a front end of the nozzle body.
